(19) United States
(12) Patent Application Publication
(10) Pub. No.: US 2015/0370813 A1
(43) Pub. Date: Dec. 24, 2015

(54) ADAPTING SERVICES OF APPLICATIONS

(71) Applicant: Infosys Limited, Bangalore (IN)

(72) Inventors: Venkat Kumar Sivaramamurthy, Bangalore (IN); Puneet Gupta, Bangalore (IN)

(21) Appl. No.: 14/715,016

(22) Filed: May 18, 2015

(30) Foreign Application Priority Data
Jun. 23, 2014 (IN) 3026/CHE/2014

(51) Int. Cl. G06F 17/30; H04L 29/06

(52) U.S. Cl. CPC G06F 17/3089; H04L 67/42

(57) ABSTRACT

A method for adapting services of applications. The method includes invoking an application installed on a device in an environment of a device. The environment of the device is sensed after the launch of the application. The sensing involve steps to obtain environment information of the device. The user requests a service in the application. A service page of the requested service is parsed to find the service tag(s) in the requested service page. Service dependency of the application on other application(s) in the environment of the device is analyzed using a mapping table. Bases on the service dependency of the application on the other application installed in the environment of the device, the enablement and/or disablement of service is decided using user configured rule(s). Based on the decision, the service is rendered on the service page of the application.

This application claims the benefit of Indian Patent Application No. 3026/CHE/2014 filed Jun. 23, 2014, which is hereby incorporated by reference in its entirety.

### FIELD OF TECHNOLOGY

The present disclosure relates generally to the field of client application adaptation and in particular, to a system, method and/or apparatus for adapting services of applications.

### BACKGROUND

There are many applications available in the market which are installed on a device. For example, a file manager application is installed on the device along with for example WhatsApp™ Messenger and Dropbox™. If the file manager application is opened and a file is selected, the file manager may offer an option to share the file. Once the share option is selected, the file manager application will display many ways through which the file can be shared like, Bluetooth™, WhatsApp™ and Dropbox™. Sometimes, Dropbox™ may be configured to upload data automatically. If the file opened is secured, if the user can share the file through Bluetooth™ and/or WhatsApp™, then it leads to a breach in security.

Presently, client applications do not sense other application(s) installed on a device or other device(s) in an environment. The client application does not sense the kind of services that the other application(s) render in the device or the other device(s) in the environment and utilizing the services that are offered by the other application(s) in the environment.

### SUMMARY

Disclosed are a method, an apparatus and/or a system for adapting services of applications in a device.

In one aspect, a method includes invoking an application installed on a device in an environment of a device by a user. As the application is launched, the environment of the device is sensed. The sensing step involve steps to obtain environment information of the device. The user requests a service in the application. A service page of the requested service is parsed to find the service tag(s) in the requested service page. The service tag(s) represents an entry point to the service of the application. Service dependency of the application on other application(s) in the environment of the device is analyzed using a mapping table in a database. Based on the service dependency of the application on the other application installed in the environment of the device, the enablement and/or disablement of service is decided using user configured rule(s). Based on the decision, the service is rendered on the service page of the application.

In another aspect, a system for adapting services of applications is disclosed. The system includes, a user input module, a sensor, a parser, an analyzer, a decision module, a rule engine, and a renderer. An application installed in an environment of a device is invoked through the user input module. The sensor collects the environment information of the device. A user request a service in the application. The parser parses the service page of the requested service. In the parsing step, the parser searches service tag(s) in the service page of the application. The service tag(s) is an entry point to the requested service. The analyzer analyses service dependency of application on other applications installed in the environment of the device. The service dependency is analyzed using a mapping table in a database. The decision module is coupled to the rule engine. The rule engine stores the rule(s). The decision module decides on enablement and/or disablement of the service based on the rules defined in the rule engine. The renderer renders the service on the service page of the application based on the decision of the decision module.

In an additional aspect, a computer readable storage medium for adapting services of applications is disclosed. The computer readable storage medium invoking an application installed on a device in an environment of a device by a user. As the application is launched, the environment of the device is sensed. The sensing step involve steps to obtain environment information of the device. The user requests a service in the application. A service page of the requested service is parsed to find the service tag(s) in the requested service page. The service tag(s) represents an entry point to the service of the application. Service dependency of the application on other application(s) in the environment of the device is analyzed using a mapping table in a database. Based on the service dependency of the application on the other application installed in the environment of the device, the enablement and/or disablement of service is decided using user configured rule(s). Based on the decision, the service is rendered on the service page of the application.

### BRIEF DESCRIPTION OF THE FIGURES

Example embodiments are illustrated by way of example and not limitation in the figures of the accompanying drawings, in which like references indicate similar elements and in which:

FIG. 1 is a diagrammatic representation of a data processing system capable of processing a set of instructions to perform any one or more of the methodologies herein, according to one embodiment.

FIG. 2 is a process flow diagram, illustrating a method for adapting services of applications, according to one or more embodiments.

FIG. 3 is a block diagram illustrating a relationship between various modules of a system for adapting services of applications, according to one or more embodiments.

FIG. 4 is a flowchart, illustrating a method for adapting services of applications, according to one or more embodiments.

FIG. 5 is a block diagram illustrating a system for adapting services of applications, according to one or more embodiments.

Other features of the present embodiments will be apparent from the accompanying drawings and from the detailed description that follows.

### DETAILED DESCRIPTION

Example embodiments, as described below, may be used to provide a method, an apparatus and/or a system of enhancing understandability of code using code clones. Although the present embodiments have been described with reference to specific example embodiments, it will be evident that various modifications and changes may be made to these embodiments without departing from the broader spirit and scope of the various embodiments.

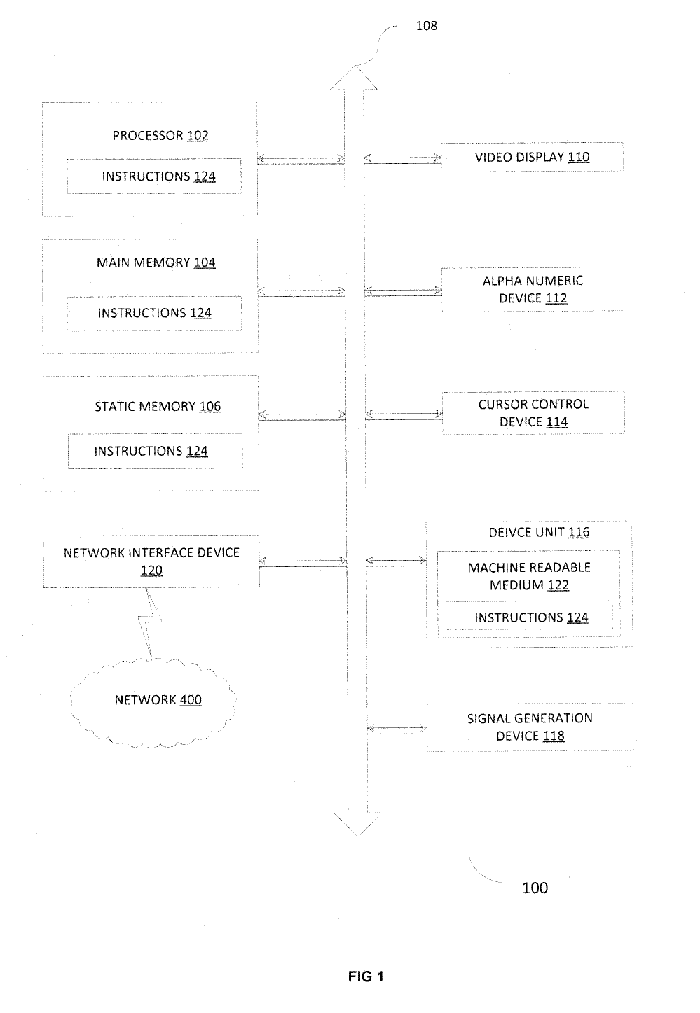

FIG. 1 is a diagrammatic representation of a data processing system capable of processing a set of instructions to perform any one or more of the methodologies herein, according to one embodiment. FIG. 1 shows a diagrammatic representation of machine in the example form of a computer system 100 or service adaptation computing device within which a set of instructions, for causing the machine to perform any one or more of the methodologies discussed herein, may be executed. In various embodiments, the machine operates as a standalone device and/or may be connected (e.g., networked) to other machines.

In a networked deployment, the machine may operate in the capacity of a server and/or a client machine in server-client network environment, and/or as a peer machine in a peer-to-peer (or distributed) network environment. The machine may be a personal—computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 100 includes a processor 102 (e.g., a central processing unit (CPU) a graphics processing unit (GPU) and/or both), a main memory 104 and a static memory 106, which communicate with each other via a bus 108. The computer system 100 may further include a video display unit 110 (e.g., a liquid crystal displays (LCD) and/or a cathode ray tube (CRT)). The computer system 100 also includes an alphanumeric input device 112 (e.g., a keyboard), a cursor control device 114 (e.g., a mouse), a disk drive unit 116, a signal generation device 118 (e.g., a speaker) and a network interface device 120.

The disk drive unit 116 includes a machine-readable medium 122 on which is stored one or more sets of instructions 124 (e.g., software) embodying any one or more of the methodologies and/or functions described herein. The instructions 124 may also reside, completely and/or at least partially, within the main memory 104 and/or within the processor 102 during execution thereof by the computer system 100, the main memory 104 and the processor 102 also constituting machine-readable media.

The instructions 124 may further be transmitted and/or received over a network 400 via the network interface device 120. While the machine-readable medium 122 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

Exemplary embodiments of this technology provide a system, method and/or apparatus for adapting services of applications. The system, method and/or apparatus for adapting services of applications involves invoking an application installed on a device in an environment of a device by a user. As the application is launched, the environment of the device is sensed. The sensing step involve steps to obtain environment information of the device. The user requests a service in the application. A service page of the requested service is parsed to find the service tag(s) in the requested service page. The service tag(s) represents an entry point to the service of the application. Service dependency of the application on other application(s) in the environment of the device is analyzed using a mapping table in a database. Based on the service dependency of the application on the other application(s) installed in the environment of the device, the enablement and/or disablement of service is decided using user configured rule(s). Based on the decision, the service is rendered on the service page of the application.

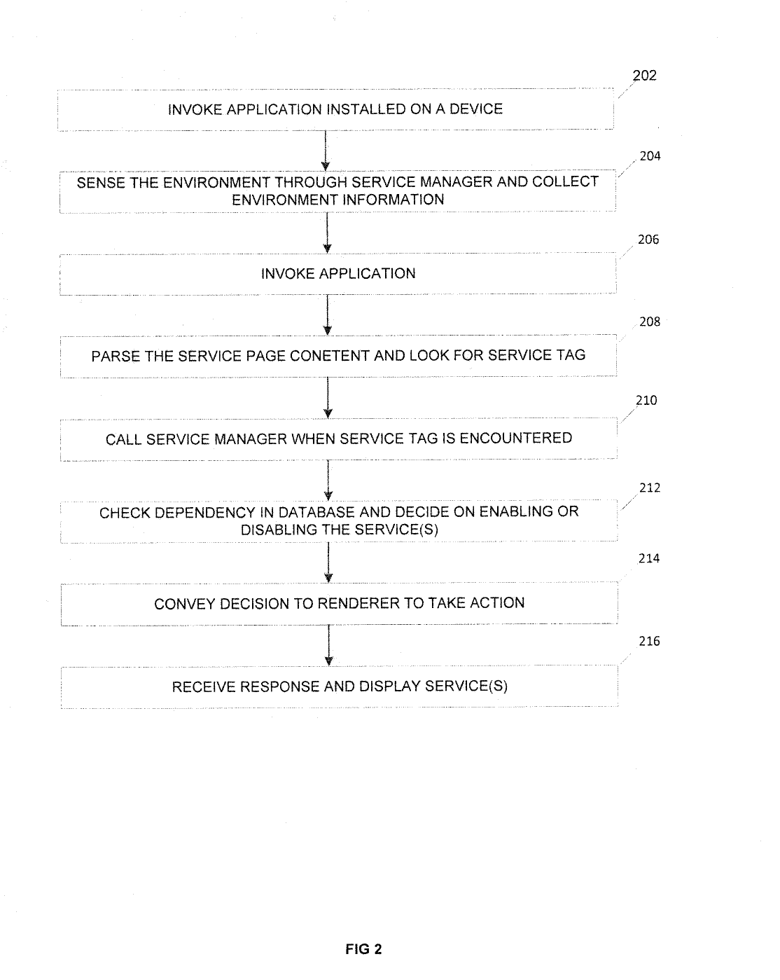

FIG. 2 is a process flow diagram, illustrating a method for adapting services of applications, according to one or more embodiments. A user may invoke an application(s) installed in an environment of a device, as in step 202. As the application(s) is launched, a service manager may sense the environment of the device, as in step 204. The service manager may collect environment information of the device. The environment information may be information of applications installed on the device, hardware specification of the device such as currently available memory to run the application, display characteristic, accessories connected to the device, available network and bandwidth, but not limited to the said information. The service manager may register itself with an operating system of the device to get notification(s) from the operating system. The notifications may be communicated to the service manager when there are any changes in the environment of the device such as any other application installed and/or uninstalled but not limited to the above changes.

In an exemplary embodiment, a printing application is installed on a device, an event may be triggered and notification(s) may be sent to a service manager. A notification may be sent to service manager informing the service manager that printing capability is available and a list of permissions availed by the application.

The operating system may collect permissions and operation information availed by an application(s) at the time of installation. The permissions and the operation information may be shared by the operating system with the service manager, when the service manager requests the operating system. The information may be provided as a consolidated summary of all the operation information and the permissions of the application(s) installed on the device, but not limited to the above said format. The service manager may update the environment database when the notification(s) is received.

The user may invoke a service page of the application, as in step 206. A renderer is configured to render a service(s) of the application. When the user invokes the service page, the service page may be parsed by a parser and may be checked for service tag(s), as in step 208. In an exemplary embodiment, the renderer may parse the service page to check the presence of the service tag(s). The service tag(s) may indicate a link(s) and the service tag(s) may be an entry point of a service. If the service tag(s) is encountered, the renderer may call the service manager, as in step 210. The service manager may check the service-environment dependency mapping database and the environment database to decide whether the service need to be enabled and/or disabled based on a rule(s), as in step 212.

The service-environment dependency database may be configured to store dependency rule(s) for enablement and/or disablement of service(s). For example, rule to enable print service(s) if printer is connected to the device. The environment database may store environment information such as other application(s) installed on the device, hardware specification of the device such as currently available memory to run the application, device settings, current CPU memory, network bandwidth and other device(s) connected to the device but not limited to above said information. The environment database may contain application(s) information and device information. The service manager may dynamically populate the environment database with the application(s) information and the device information. The environment database may be dynamically populated when applications are installed and/or uninstalled. The environment database may also be dynamically populated when other device(s) is connected and/or disconnected with the device. The service manager may obtain the application(s) information and the device information from the operating system of the device. The service manager may check the service-environment dependency database and the environment database when the renderer calls the service manager at the time of request by the user and may decide on the enabling and/or disabling the service(s).

In an exemplary embodiment, a service manager may also perform the check in background and may provide the decision, when renderer calls the service manager. In another embodiment, service-environment dependency database and environment database may be a single database.

When the service manager decides on the enabling and/or disabling the service(s), the result may be sent to the renderer, as in step 214. The renderer may receive the response from the service manager and may render the appropriate service(s) based on the response of the service manager. For example, a link for a service may not be displayed in the service page based on the response of the service manager. The user may configure a rule to enable and/or disable the service(s) of the application. In an exemplary embodiment, a user may set a rule to disable a service(s) when temporary memory available in a device is below a fixed value, say 1 GigaByte. Accordingly, in step 216, a response is received from the renderer and the service(s) are displayed.

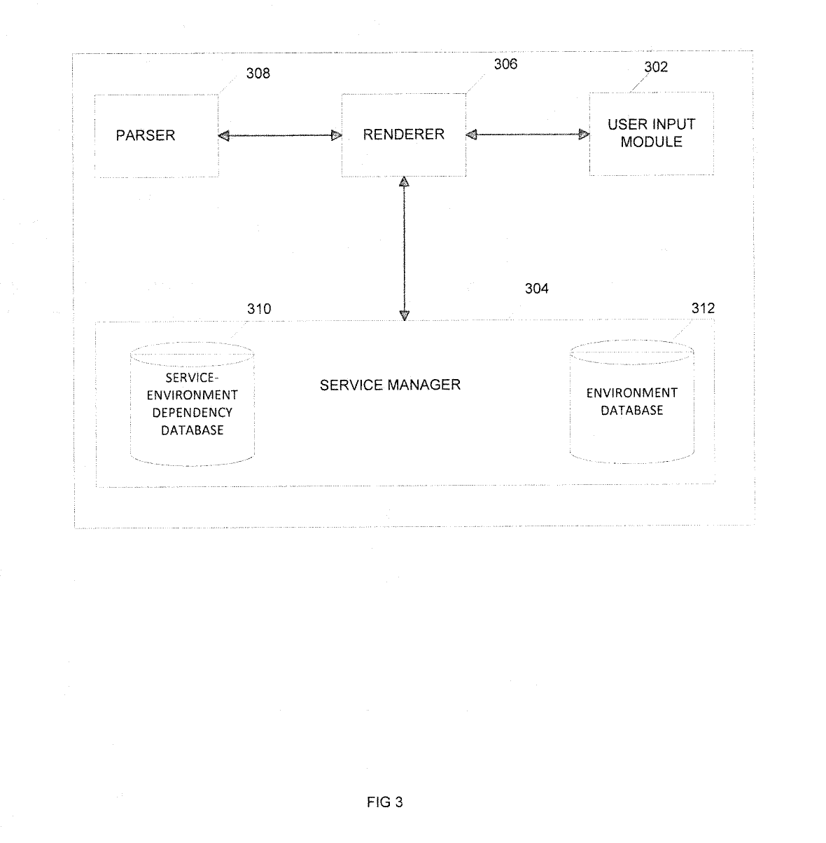

FIG. 3 is a block diagram illustrating a service adaptation computing device or system for adapting services of applications, according to one or more embodiments. The system includes a user input module 302, a service manager 304, a renderer 306, a parser 308, a service-environment dependency database 310, and a environment database 312. The user input module 302 is configured to receive input from a user. The user may invoke an application installed in an environment of a device. As the application is launched, the service manager 304 may be configured to sense the environment. The service manager 304 may sense the environment. The service manager may collect environment information of the device. The environment information may be information of applications installed on the device, hardware specification of the device such as currently available memory to run the application, display characteristics, accessories connected to the device, available network and bandwidth, but not limited to the said information. The service manager 304 may register itself with an operating system of the device to get notification(s) from the operating system. The notification(s) may be communicated to the service manager 304 when there are any changes in the environment such as any other application installed and/or uninstalled but not limited to the above changes.

In an exemplary embodiment, a printing application is installed on a device, an event may be triggered and a notification(s) may be sent to the service manager 304. In another embodiment, the notification may inform the service manager 304 that printing capability is available and a list of permissions availed by the application. The operating system may collect permissions and operation information availed by the applications at the time of installation. The permissions and the operation information may be shared by the operating system when service manager 304 requests the operating system. The information may be provided as a consolidated summary of all the permissions and the operation information of the application(s), but not limited to the above said format. The service manager may update the environment database 312 when the notification(s) are received from the operating system.

The service-environment dependency 310 database may be configured to store dependency rule(s) for enablement and/or disablement of service(s). For example, rule to enable print service(s) if printer is connected to the device. The environment database 312 may store environment information such as other application(s) installed on the device, hardware specification of the device such as currently available memory to run the application, device settings, current CPU memory, network bandwidth and other device(s) connected to the device but not limited to above said information. In an exemplary embodiment, the environment database 312 may contain application(s) information and device information, preloaded by a developer. In another embodiment, the service manager 304 may dynamically populate the environment database 312 with the application(s) information and the device information. The environment database may be dynamically populated when applications are installed and/or uninstalled. The environment database may also be dynamically populated when other device(s) is connected and/or disconnected with the device. The service manager 304 may obtain the application(s) information and the device information from the operating system of the device.

The renderer 306 may be configured to render an interface to the user. The user may invoke the service page and the service page may be parsed by the parser 308 and checked for presence of service tag(s). The parser 308 may be configured to parse the service page requested by the user. In an exemplary embodiment, a renderer 306 may parse the service page. The service tag(s) may indicate a link(s). The link(s) may be an entry point of a service(s). When the service tag(s) is encountered, the renderer 306 may call the service manager 304. The service manager 304 may check service-environment dependency database 310 and environment database 312 to decide whether the service need to be enabled and/or disabled.

The service manager 304 may check the check service-environment dependency database 310 and the environment database 312 when the renderer 306 calls the service manager 304 at the time of request by the user and may decide on enabling and/or disabling the service(s). In an exemplary embodiment, a service manager 304 may also perform the check in background and may provide the decision immediately, when there is a call from a renderer 306. In another embodiment, service-environment dependency database 310 and environment database 312 may be a single database. The check performed by the service manager 304 may not be limited to the said cases. The decision for enabling and/or disabling the service(s) may be sent to the renderer 306. The renderer 306 may receive the response from the service manager 304 and may render the appropriate service(s) based on the response of the service manager 304.

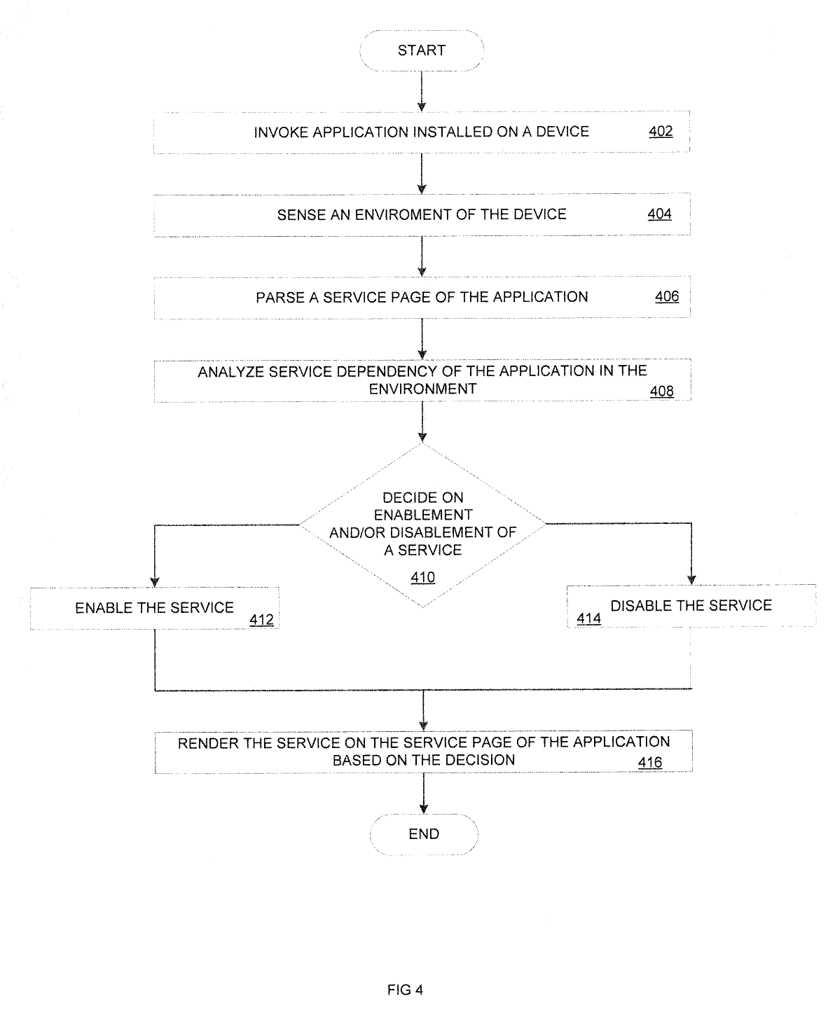

FIG. 4 is a flowchart, illustrating a computer implemented method for adapting services of applications, according to one or more embodiments. An application installed in an environment of a device may be invoked, as in step 402. The application may be invoked by a user. The user may use a user interface to invoke the application. In an exemplary embodiment, the application may be invoked by other application(s) installed on the device. An environment of the device may be sensed, as in step 404. The environment may be sensed when the application is invoked. The environment may be sensed to get environment information of the device. The environment information includes information of other application(s) installed on the device, hardware specification of the device such as currently available memory to run the application, display characteristic, accessories connected to the device, available network and bandwidth, but not limited to the said information. A service may be requested by the user through the application. A requested service page of the application may be parsed, as in step 406. The service page may be searched for service tag(s). The service tag(s) may be link(s). The link(s) may be an entry point for service(s).

Service dependency of the application on one or more application installed in the environment of the device may be analyzed, as in step 408. The step 408 may also include analyzing the service dependency of the application on other device(s) connected to the device in the environment. The service dependency of the application may be checked using mapping table in a database(s). In the present embodiment, the service dependency may be checked when the service tag(s) are found in the requested service page. In another embodiment, the service dependency may be analyzed and results are stored temporarily in a memory for immediate access. The step 408 is carried out using one or more table(s) in the database(s).

In the present embodiment, the database(s) used are service-environment dependency database and environment database. In another embodiment the service environment dependency database and the environment database may be combined to one database.

The service-environment dependency database may be configured to store dependency rule(s) for enablement and/or disablement of service(s). For example, rule to enable print service(s) if printer is connected to the device. The environment database may store environment information such as other application(s) installed on the device, hardware specification of the device such as currently available memory to run the application, device settings, current CPU memory, network bandwidth and other device(s) connected to the device but not limited to above said information. In an exemplary embodiment, the environment database may contain application(s) information and device information. The service manager may dynamically populate the environment database with the application(s) information and the device information. The environment database may be dynamically populated when applications are installed and/or uninstalled. The environment database may also be dynamically populated when other device(s) is connected and/or disconnected with the device. The service manager may obtain the application(s) information and the device information from the operating system of the device.

One of an enablement and/or disablement of the service(s) may be decided, as in step 410. The decision of the step 410 is based on rule(s). The rule(s) may be pre-defined and/or created during the process of enablement and/or disablement of the service(s).

Upon the decision being enablement in the step 410, the service(s) may be enabled as in step 412. Upon the result being disablement in the step 410, the service(s) may be disabled as in step 414. The service(s) are displayed on the service page of the application as in step 416, based on the decision of the step 410.

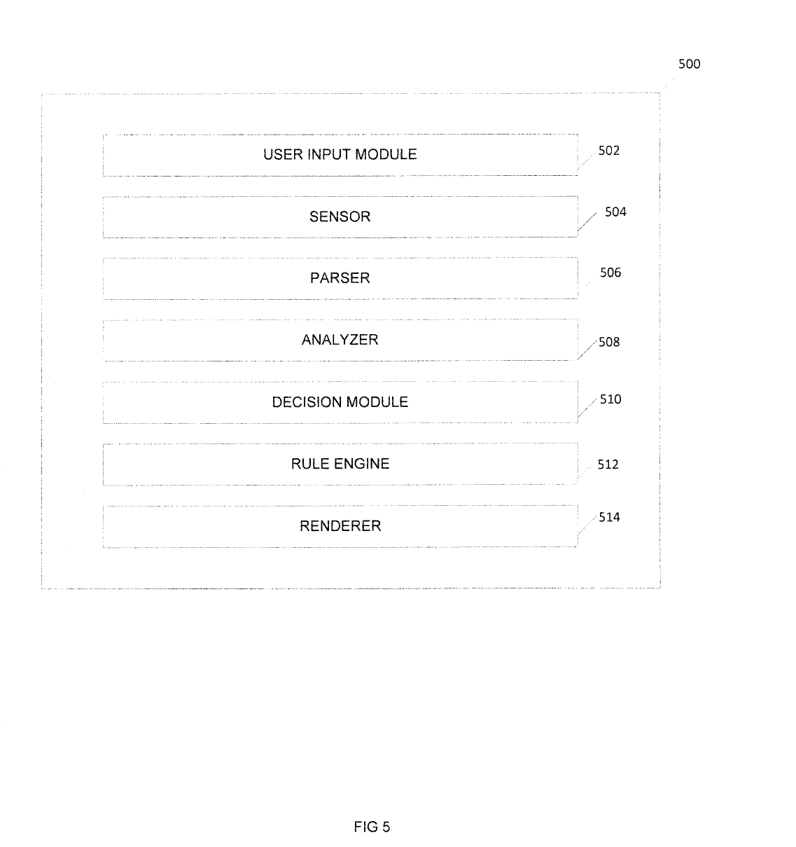

FIG. 5 is a block diagram, illustrating a service adaptation computing device or system for adapting services of applications, according to one or more embodiments. The system includes a user input module 502, a sensor 504, a parser 506, an analyzer 508, a decision module 510, a rule engine 512 and a renderer 514. The user input module 502, may be configured to invoke an application installed on a device.

In the present embodiment, the application may be invoked through the user input module 502. In another embodiment, application may be invoked by other application(s) installed on the device.

The sensor 504, may be configured to sense environment of the device. The sensor 504, may collect environment information of the device. The sensor 504 may be associated with the service manager 304. The environment information may include information of application(s) installed on the device, hardware specification of the device such as currently available memory to run the application, display characteristic, accessories connected to the device, available network and bandwidth, but not limited to the said information. The parser 506, may configured to parse a service page requested in the application. The parser 506 may scan the service page to find the service tag(s).

In the present embodiment, the parser 506 may call the analyzer 508 when the service tag(s) is found in the service page. In another embodiment, the service dependency may be analyzed and results are stored temporarily in a memory for immediate access.

The analyzer 508 may be configured to analyze the service dependency of the application on one or more application(s) installed in the environment of the device. The analyzer 508 may also be configured to analyze the service dependency of the application on other devices connected to the device in an environment of the device. The service dependency of the application may be checked using mapping table in a database(s). In the present embodiment, the database(s) used are service-environment dependency database and environment database.

The service-environment dependency database may be configured to store dependency rule(s) for enablement and/or disablement of service(s). For example, rule to enable print service(s) if printer is connected to the device. The environment database may store environment information such as other application(s) installed on the device, hardware specification of the device such as currently available memory to run the application, device settings, current CPU memory, network bandwidth and other device(s) connected to the device but not limited to above said information. In an exemplary embodiment, the environment database may contain application(s) information and device information. The service manager may dynamically populate the environment database with the application(s) information and the device information. The environment database may be dynamically populated when applications are installed and/or uninstalled. The environment database may also be dynamically populated when other device(s) is connected and/or disconnected with the device. The service manager may obtain the application(s) information and the device information from the operating system of the device.

The decision module 510, may be configure to decide on one of an enablement and/or disablement of service(s). The decision module 510, may be communicatively coupled to the rule engine 512. The rule engine 512, may be configured to store rule(s) for one of an enablement and/or disablement of the service(s). The rule(s) may be pre-defined and/or created during the process of enablement and/or disablement of the service(s).The renderer 514 may be configured to display the services(s) in the application based on the decision of the decision module 510.

In the present embodiment, the decision is one of an enablement and/or disablement of the service(s). In an additional embodiment, the decision is one of a partial-enablement and/or partial-disablement of the service(s).

In an example embodiment, a document reader application may be installed in an environment of a device. A user may invoke the document reader application on a user interface of a device. The document reader application may sense the device to get environment information of the device. The environment information may include hardware specification of the device, amount of temporary storage available on the device, stored in the environment database. If there is no enough temporary memory available on the device, the document reader may not be started. After starting the document reader, the user may select any file(s) which are listed in the document reader application. Selection of file to read may be a service of the document reader application. Once the file(s) is selected, a parser may parse service page of the requested file(s). If service tag(s) are found in the service page of the requested file(s) the parser may call service manager to analyze service dependency of the document reader application on other application(s). The service dependency may be a dependency of service of one application on other application(s). The service manager analyses service-environment dependency database, which may contain data related to dependency of service of an application on other application(s). The service manager may check whether any printing application(s) and/or screen capturing application and/or data sharing application(s) like Bluetooth™ and/or WhatsApp™ is installed in the environment of the device. If the file opened by the user is secured, the services like screen capture service, printing service, sharing service may be disabled. If the file is not secured, the screen capture service, the printing service, the sharing service may be enabled. If the device don't have printer connected, the printing service may be disabled if file is not secured.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry, firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or in Digital Signal Processor (DSP) circuitry).

In addition, it will be appreciated that the various operations, processes, and methods disclosed herein may be embodied in a machine-readable medium and/or a machine accessible medium compatible with a data processing system (e.g., a computer devices), and may be performed in any order (e.g., including using means for achieving the various operations). Various operations discussed above may be tangibly embodied on a medium readable through the retail portal to perform functions through operations on input and generation of output. These input and output operations may be performed by a processor. The medium readable through the retail portal may be, for example, a memory, a transportable medium such as a CD, a DVD, a Blu-ray™ disc, a floppy disk, or a diskette. A computer program embodying the aspects of the exemplary embodiments may be loaded onto the retail portal. The computer program is not limited to specific embodiments discussed above, and may, for example, be implemented in an operating system, an application program, a foreground or background process, a driver, a network stack or any combination thereof. The computer program may be executed on a single computer processor or multiple computer processors.

Accordingly, the specification and drawings are to be regarded in an illustrative rather than a restrictive sense.

What we claim is:

1. A method for adapting application services, the method comprising:
obtaining, by a service adaptation computing device, environment data;
parsing, by the service adaptation computing device, a service page of the application to identify one or more service tags;
analyzing, by the service adaptation computing device, a service dependency of the application based on the environment data and one or more service tags;
determining, by the service adaptation computing device, when a service should be enabled based on the application of one or more rules to a result of the analysis; and
rendering, by the service adaptation computing device, the service on the service page of the application when the determining indicates the service should be enabled.

2. The method of claim 1, wherein the application is invoked using a user interface.

3. The method of claim 1, wherein the service dependency of the application is analyzed using at least one mapping table in a database.

4. The method of claim 1, wherein the environment data is obtained subsequent to an invocation of the application.

5. The method of claim 1, wherein the service page is parsed when the service page is requested.

6. A service adaptation computing device, a service dependency of the application based on the environment data and comprising at least one processor and a memory coupled to the processor which is configured to be capable of executing programmed instructions comprising and stored in the memory to:
obtaining environment data;
parsing a service page of the application to identify one or more service tags;
analyzing a service dependency of the application based on the environment data and one or more service tags;
determining when a service should be enabled based on the application of one or more rules to a result of the analysis; and
rendering the service on the service page of the application when the determining indicates the service should be enabled.

7. The service adaptation computing device of claim 6, wherein the application is invoked using a user interface.

8. The service adaptation computing device of claim 6, wherein the service dependency of the application is analyzed using at least one mapping table in a database.

9. The service adaptation computing device of claim 6, wherein the environment data is obtained subsequent to an invocation of the application.

10. The service adaptation computing device of claim 6, wherein the service page is parsed when the service page is requested.

11. A non-transitory computer-readable storage medium having stored thereon instructions for adapting application services, the instructions comprising machine executable code which, when executed by at least one processor, causes the processor to perform steps comprising:
obtain environment data;
parse a service page of the application to identify one or more service tags;
analyze a service dependency of the application based on the environment data and one or more service tags;
determine when a service should be enabled based on the application of one or more rules to a result of the analysis; and
render the service on the service page of the application when the determining indicates the service should be enabled.

12. The non-transitory computer readable medium of claim 11, wherein the application is invoked using a user interface.

13. The non-transitory computer readable medium of claim 11, wherein the service dependency of the application is analyzed using at least one mapping table in a database.

14. The non-transitory computer readable medium of claim 11, wherein the environment data is obtained subsequent to an invocation of the application.

15. The non-transitory computer readable medium of claim 11, wherein the service page is parsed when the service page is requested.
